(19) United States
(12) Patent Application Publication
(10) Pub. No.: US 2016/0029452 A1
(43) Pub. Date: Jan. 28, 2016

(54) LIGHTING APPARATUS

(71) Applicant: SILICON WORKS CO., LTD., Daejeon-si (KR)

(72) Inventors: Yong Geun KIM, Suwon-si (KR); Sang Young LEE, Jeonju-si (KR); Ki Chul AN, Daegu-si (KR)

(21) Appl. No.: 14/805,799

(22) Filed: Jul. 22, 2015

(30) Foreign Application Priority Data
Jul. 23, 2014 (KR) 10-2014-0093214

(51) Int. Cl. H05B 33/08; F21S 4/00

(52) U.S. Cl. CPC H05B 33/0827; F21S 4/008; F21Y 2103/003

(57) ABSTRACT

Provided is a lighting apparatus using an LED as a light source. The lighting apparatus may include a plurality of light emitting units each including one or more semiconductor packages having an equal number of LEDs mounted thereon, the light emitting units may be arranged in a longitudinal direction to form a line light source, and the LEDs included in each of the light emitting units may be divided into a plurality of LED groups.

### BACKGROUND

1. Technical Field

The present disclosure relates to a lighting apparatus, and more particularly, to a lighting apparatus using an LED as a light source.

2. Related Art

In order to reduce energy, a lighting apparatus is designed to use a light source having high light emission efficiency based on a small amount of energy. Representative examples of a light source used in the lighting apparatus may include a light emitting diode (LED). The LED is differentiated from other light sources in terms of various aspects such as energy consumption, lifetime, and light quality.

Since the LED is driven by a current, a lighting apparatus using the LED as a light source requires a large number of additional circuits for current driving. In order to solve the above-described problem, an AC direct-type lighting apparatus has been developed to provide an AC voltage to the LED.

The AC direct-type lighting apparatus is configured to convert an AC voltage into a rectified voltage, and control the LED to emit light through current driving using the rectified voltage. Since the AC direct-type lighting apparatus directly uses a rectified voltage without using an inductor and capacitor, the AC direct-type lighting apparatus has a satisfactory power factor. The rectified voltage indicates a voltage obtained by full-wave rectifying an AC voltage.

The lighting apparatus may be manufactured in various shapes depending on the use thereof. A lighting apparatus used as mood lighting or indirect lighting in a room or shop may be designed in a tube type which has a small width and is extended in the longitudinal direction. When the lighting apparatus is designed in a tube type, the lighting apparatus is required to have uniform luminance as a whole. Furthermore, the lighting apparatus must be designed to have a satisfactory PF (Power Factor) and THD (Total Harmonic Distortion).

The lighting apparatus may a plurality of chips arranged in rows and columns and each including one LED mounted therein. The LED chips must be arranged so as to be spaced at the minimum distance or more from each other. Furthermore, a plurality of wirings for driving the LED chips must be formed on the surface of a substrate, on which the LED chips are mounted. The plurality of wirings must also be arranged so as to be spaced at the minimum distance or more from each other.

Thus, when the lighting apparatus is designed in a tube type having a small width, there is a limitation in designing the lighting apparatus such that the plural rows of LED chips and the plurality of wirings maintain a sufficient distance from each other.

Furthermore, when the lighting apparatus is driven by a rectified voltage, the LEDs of the lighting apparatus may be divided into a plurality of LED groups. The plurality of LED groups sequentially emit light. Thus, when the conventional tube-type lighting apparatus extended in the longitudinal direction is designed, there are difficulties in that the entire surface thereof cannot exhibit uniform luminance and THD cannot be sufficiently considered.

### SUMMARY

Various embodiments are directed to a lighting apparatus capable of forming a line light source using LEDs.

Also, various embodiments are directed to a lighting apparatus in which a semiconductor package having a plurality of LEDs mounted thereon is repetitively provided on a substrate having a small width in order to form a line light source, and which is capable of securing uniform luminance.

Also, various embodiments are directed to a lighting apparatus which is capable of controlling light emissions of LEDs mounted in a light emitting unit including one or more semiconductor packages on a basis of LED groups obtained by dividing the LEDs at an integer ratio, thereby achieving satisfactory THD.

In an embodiment, there is provided a lighting apparatus may include a plurality of light emitting units each including one or more semiconductor packages having an equal number of LEDs mounted thereon The light emitting units may be arranged in order to form a line light source, each of the light emitting units may include a plurality of LEDs corresponding to a multiple of six, the LEDs may be divided into first to fourth LED groups which sequentially emit light, and the numbers of LEDs included in the first to fourth LED groups, respectively, may be set to a ratio of 2:2:1:1.

In another embodiment, a lighting apparatus may include a plurality of light emitting units including one or more semiconductor packages having an equal number of LEDs mounted thereon. The LED units may be arranged in order to form a line light source, the LEDs included in each of the light emitting units may be divided into first to third LED groups which sequentially emit light, and the numbers of LEDs included in the first to third LED groups, respectively, are may be to a ratio of 2:1:1.

In another embodiment, a lighting apparatus may include: a plurality of light emitting units arranged in order to form a line light source and each including one or more semiconductor packages having an equal number of LEDs mounted thereon and including a plurality of LEDs corresponding to a multiple of six; and a driving circuit configured to selectively provide a current path to the plurality of LED groups in response to sequential light emissions of the plurality of LED groups according to changes of a rectified voltage. The LEDs included in each of the light emitting units may be divided into first to fourth LED groups which sequentially emit light, and the numbers of LEDs included in the first to fourth LED groups, respectively, may be set to a ratio of 2:2:1:1.

### BRIEF DESCRIPTION OF THE DRAWINGS

FIG. 1 is a block diagram illustrating a lighting apparatus in accordance with an embodiment of the present invention.

FIG. 2 is a diagram for describing light emissions based on changes of a rectified voltage.

FIG. 3 is a detailed circuit diagram of a driving circuit of FIG. 1.

FIG. 4 is a diagram illustrating an example in which light emitting units are arranged in a lighting unit of FIG. 1.

FIG. 5 is a diagram illustrating the circuit configuration of the lighting unit corresponding to FIG. 4.

FIG. 6 is a diagram illustrating another example in which light emitting units are arranged in the lighting unit of FIG. 1.

FIG. 7 is a diagram illustrating the circuit configuration of the lighting unit corresponding to FIG. 6.

FIG. 8 is a diagram illustrating another example in which the light emitting units are arranged in the lighting unit of FIG. 1.

### DETAILED DESCRIPTION

Exemplary embodiments will be described below in more detail with reference to the accompanying drawings. The disclosure may, however, be embodied in different forms and should not be constructed as limited to the embodiments set forth herein. Rather, these embodiments are provided so that this disclosure will be thorough and complete, and will fully convey the scope of the disclosure to those skilled in the art. Throughout the disclosure, like reference numerals refer to like parts throughout the various figures and embodiments of the disclosure.

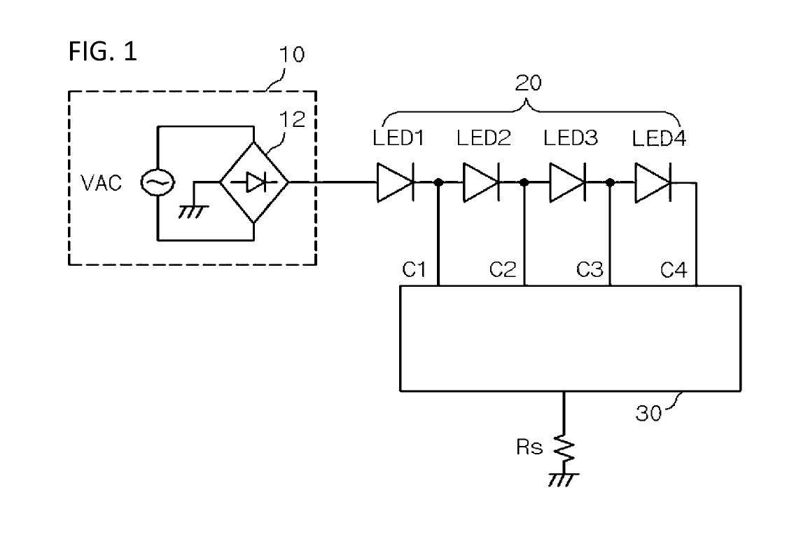

FIG. 1 is a block diagram illustrating a lighting apparatus in accordance with an embodiment of the present invention. The embodiment of FIG. 1 may include a power supply circuit 10, a lighting unit 20, and a driving circuit 30.

The power supply circuit 10 may be configured to provide a rectified voltage to the lighting unit 20. For this operation, the power supply circuit 10 may include an AC power source VAC and a rectifier 12. The AC power source VAC may be implemented with a common AC power source, and provide an AC voltage. The rectifier 12 may full-wave rectify the AC voltage of the AC power source VAC, and output the rectified voltage. The rectifier 12 may have a typical bridge diode structure.

According to the above-described configuration, the power supply circuit 10 may output a rectified voltage, and have a ripple corresponding to the half cycle of an AC voltage. Hereafter, the change of a rectified voltage in the embodiment of the present invention is defined as the increase/decrease of a ripple.

The lighting unit 20 may emit light in response to a rectified voltage, and include a plurality of LEDs. The plurality of LED groups included in the lighting unit 20 may be divided into a plurality of LED groups, and FIG. 1 illustrates that the lighting unit 20 includes four LED groups LED1 to LED4. The number of LED groups may be set to various values according to a designer's intention. Furthermore, each of the LED groups LED1 to LED4 may include one or more LED or a plurality of LEDs in series, in parallel, or in serial-parallel to each other.

The driving circuit 30 may provide a current path for light emission of the lighting unit 20.

More specifically, the driving circuit 30 may be configured to provide a current path to any one of the LED groups LED1 to LED4 in response to light emission of the lighting unit 20 based on a change of the rectified voltage, and perform current regulation on the current path. For this operation, the driving circuit 30 may include terminals C1 to C4 connected to the respective output terminals of the LED groups LED1 to LED4 included in the lighting unit 20. The driving circuit 30 may be connected to a sensing resistor Rs for forming a current path.

The driving circuit 30 may provide a current path between the terminal C1 and the sensing resistor Rs when only the LED group LED1 emits light, provide a current path between the terminal C2 and the sensing resistor Rs when only the LED groups LED1 and LDE2 emit light, provide a current path between the terminal C3 and the sensing resistor Rs when only the LED groups LED1 to LED3 emit light, and provide a current path between the terminal C4 and the sensing resistor Rs when all of the LED groups LED1 to LED4 emit light.

The driving circuit 30 may use a sensing voltage of the sensing resistor Rs in order to provide a current path. The driving circuit 30 may compare the sensing voltage corresponding to a current flowing through the sensing resistor Rs to internal reference voltages provided in response to the respective LED groups LED1 to LED4. According to the comparison results between the sensing voltage and the reference voltages, the driving circuit 30 may provide a current path for connecting the sensing resistor Rs to any one terminal C1, C2, C3, or C4.

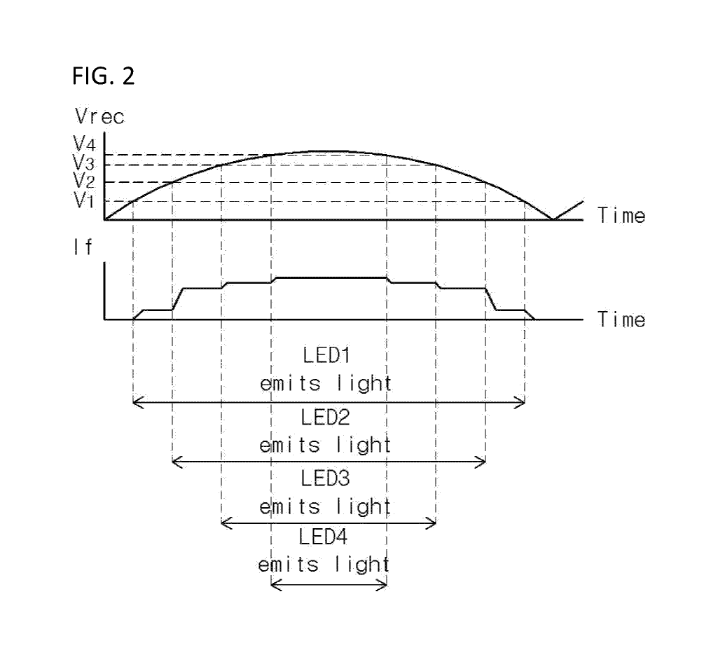

FIG. 2 is a diagram for describing light emissions of the LED groups LED1 to LED4, corresponding to a cycle of rectified voltage Vrec. In FIG. 2, V1 to V4 represent light emission voltages of the LED groups LED1 to LED4.

The rectified voltage Vrec provided to the lighting unit 20 may have a ripple which periodically increases/decreases. When the rectified voltage Vrec rises over the light emission voltage V1, the LED group LED1 may emit light. When the rectified voltage Vrec rises over the light emission voltage V2, the LED groups LED1 and LED2 may emit light. When the rectified voltage Vrec rises over the light emission voltage V3, the LED groups LED1 to LED3 may emit light. When the rectified voltage Vrec rises over the light emission voltage V4, the LED groups LED1 to LED4 may emit light.

In response to the sequential light emissions of the LED groups LED1 to LED4, the amount of current If on the current path provided by the driving circuit 30 and the sensing resistor Rs may be changed in a stepwise manner. That is, the current If of the sensing resistor Rs may have a stepped waveform which increases or decreases in a stepwise manner in response to changes of the current path. Furthermore, the change of the current If may be sensed through the sensing voltage of the sensing resistor Rs. The current If of the sensing resistor Rs may be controlled to a constant current in response to light emissions of the LED groups.

That is, when the rectified voltage Vrec rises, the number of LED groups to emit light may increase, and when the rectified voltage Vrec falls, the number of LED groups to emit light may decrease. The driving circuit 30 may provide a changed current path in response to the change in light emitting state of the lighting unit 20, and the current on the current path may be changed in a stepwise manner.

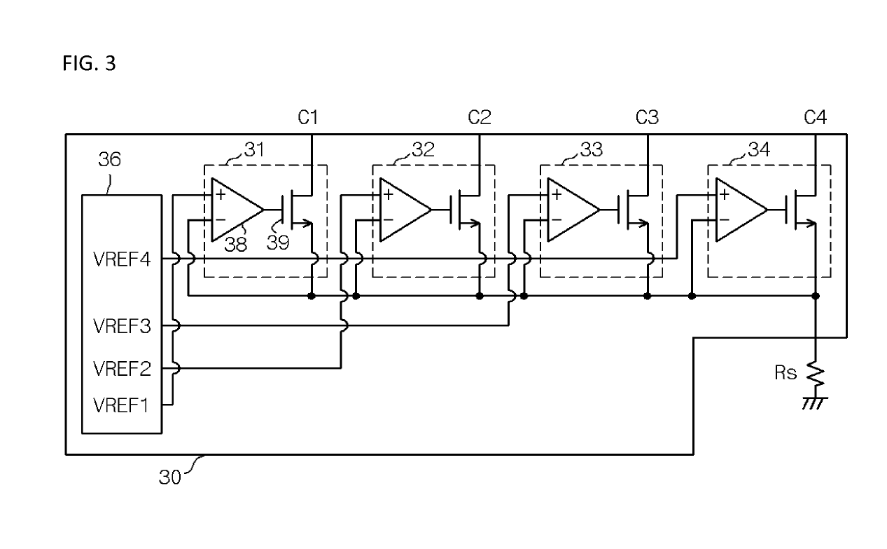

The driving circuit 30 which provides a current path and performs current regulation as described above may be configured as illustrated in FIG. 3.

The driving circuit 30 may include a plurality of switching circuits 31 to 34 and a reference voltage supply unit 36. The plurality of switching circuits 31 to 34 may be configured to provide a current path for the LED groups LED1 to LED4, and the reference voltage supply unit 36 may be configured to provide reference voltages VREF1 to VREF4.

The reference voltage supply unit 36 may be configured to provide the reference voltages VREF1 to VREF4 having different levels according to a designer's intention.

The reference voltage supply unit 36 may include a plurality of resistors which are connected in series to receive a constant voltage, for example. The reference voltage supply unit 36 may output the reference voltages VREF1 to VREF4 having different levels through the respective nodes among the resistors. In another embodiment, the reference voltage supply unit 36 may include independent voltage supply sources for providing the reference voltages VREF1 to VREF4 having different levels.

Among the reference voltages VREF1 to VREF4 having different levels, the reference voltage VREF1 may have the lowest voltage level, and the reference voltage VREF4 may have the highest voltage level. The voltage levels of the reference voltages may gradually increase in order of VREF1, VREF2, VREF3, and VREF4.

The reference voltage VREF1 may have a level for turning off the switching circuit 31 at the point of time that the LED group LED2 emits light. More specifically, the reference voltage VREF1 may be set to a lower level than the sensing voltage which is formed in the sensing resistor Rs at the point of time that the LED group LED2 emits light.

The reference voltage VREF2 may have a level for turning off the switching circuit 32 at the point of time that the LED group LED3 emits light. More specifically, the reference voltage VREF2 may be set to a lower level than the sensing voltage which is formed in the sensing resistor Rs at the point of time that the LED group LED3 emits light.

The reference voltage VREF3 may have a level for turning off the switching circuit 33 at the point of time that the LED group LED4 emits light. More specifically, the reference voltage VREF3 may be set to a lower level than the sensing voltage which is formed in the sensing resistor Rs at the point of time that the LED group LED4 emits light.

Furthermore, the reference voltage VREF4 may be set in such a manner that the current flowing through the sensing resistor Rs becomes a constant current in the upper limit-level region of the rectified voltage Vrec.

The switching circuits 31 to 34 may be commonly connected to the sensing resistor Rs which provides a sensing voltage, in order to perform current regulation and form a current path.

The switching circuits 31 to 34 may compare the sensing voltage of the sensing resistor Rs to the reference voltages VREF1 to VREF4 of the driving circuit 30, and form a selective current path for turning on the lighting unit 20.

Each of the switching circuits 31 to 34 may receive a high-level reference voltage, as the switching circuit is connected to an LED group remote from the position to which the rectified voltage is applied.

Each of the switching circuits 31 to 34 may include a comparator 38 and a switching element, and the switching element may include an NMOS transistor 39.

The comparator 38 included in each of the switching circuits 31 to 34 may have a positive input terminal (+) configured to receive a reference voltage, a negative input terminal (−) configured to receive a sensing voltage, and an output terminal configured to output a result obtained by comparing the reference voltage and the sensing voltage.

The NMOS transistor 39 included in each of the switching circuits 31 to 34 may perform a switching operation according to the output of the comparator 38, which is applied to the gate thereof. The drain of the NMOS transistor 39 and the negative input terminal (−) of the comparator 38 may be commonly connected to the sensing resistor Rs.

According to the above-described configuration, the sensing resistor Rs may apply the sensing voltage to the input terminal (−) of the comparator 38, and provide a current path corresponding to any one of the NMOS transistors 39 of the respective switching circuits 31 to 34.

The lighting apparatus in accordance with the embodiment of the present invention may sequentially turn on or off the LED groups LED1 to LED4 in response to the changes of the rectified voltage Vrec, and selectively provide a current path through the driving circuit 30 in response to the sequential turn-on/off of the LED groups LED1 to LED4. The driving circuit 30 may regulate a current passing through the current path. As a result, the driving circuit may provide a constant current to the lighting unit 20.

More specifically, the operation of the lighting apparatus in accordance with the embodiment of the present invention will be described with reference to FIGS. 1 to 3.

When the rectified voltage Vrec is in the initial state, all of the switching circuits 31 to 34 may maintain the turn-on state because the reference voltages VREF1 to VREF4 applied to the positive input terminals (+) thereof are higher than the sensing voltage of the sensing resistor Rs, which is applied to the negative input terminals (−) thereof.

Then, when the rectified voltage Vrec rises to reach the light emission voltage V1, the LED group LED1 may emit light. Then, when the LED group LED1 of the lighting unit 20 emits light, the switching circuit 31 connected to the LED group LED1 may provide a current path.

When the rectified voltage Vrec reaches the light emission voltage V1 such that the LED group LED1 emits light and the current path is formed through the switching circuit 31, the level of the sensing voltage of the sensing resistor Rs may rise. However, since the level of the sensing voltage is low, the turn-on states of the switching circuits 31 to 34 may not be changed.

Then, when the rectified voltage Vrec continuously rises to reach the light emission voltage V2, the LED group LED2 may emit light. When the LED group LED2 emits light, the switching circuit 32 connected to the LED group LED2 may provide a current path. At this time, the LED group LED1 may also maintain the light emitting state.

When the rectified voltage Vrec reaches the light emission voltage V2 such that the LED group LED2 emits light and the current path is formed through the switching circuit 32, the level of the sensing voltage of the sensing resistor Rs may rise. At this time, the sensing voltage may have a higher level than the reference voltage VREF1. Therefore, the NMOS transistor 39 of the switching circuit 31 may be turned off by an output of the comparator 38. That is, the switching circuit 31 may be turned off, and the switching circuit 32 may provide a selective current path corresponding to the light emission of the LED group LED2.

Then, when the rectified voltage Vrec continuously rises to reach the light emission voltage V3, the LED group LED3 may emit light. When the LED group LED3 emits light, the switching circuit 33 connected to the LED group LED3 may provide a current path. At this time, the LED groups LED1 and LED2 may also maintain the light emitting state.

When the rectified voltage Vrec reaches the light emission voltage V3 such that the LED group LED3 emits light and the current path is formed through the switching circuit 33, the level of the sensing voltage of the sensing resistor Rs may rise. At this time, the sensing voltage may have a higher level than the reference voltage VREF2. Therefore, the NMOS transistor 39 of the switching circuit 32 may be turned off by an output of the comparator 38. That is, the switching circuit 32 may be turned off, and the switching circuit 33 may provide a selective current path corresponding to the light emission of the LED group LED3.

Then, when the rectified voltage Vrec continuously rises to reach the light emission voltage V4, the LED group LED4 may emit light. When the LED group LED4 emits light, the switching circuit 34 connected to the LED group LED4 may provide a current path. At this time, the LED groups LED1 to LED3 may also maintain the light emitting state.

When the rectified voltage reaches the light emission voltage V4 such that the LED group LED4 emits light and the current path is formed through the switching circuit 34, the level of the sensing voltage of the sensing resistor Rs may rise. At this time, the sensing voltage may have a higher level than the reference voltage VREF3. Therefore, the NMOS transistor 39 of the switching circuit 33 may be turned off by an output of the comparator 38. That is, the switching circuit 33 may be turned off, and the switching circuit 34 may provide a selective current path corresponding to the light emission of the LED group LED4.

Then, although the rectified voltage Vrec continuously rises, the switching circuit 34 may maintain the turn-on state.

When the LED groups LED1 to LED4 sequentially emit light in response to the rises of the rectified voltage Vrec, the current of the current path may increase in a stepwise manner as illustrated in FIG. 2, in response to the light emitting states. Then, the current flowing through the current path may maintain a constant level through current regulation. When the number of LED groups to emit light increases, the level of the current on the current path may rise in response to the increase in number of LED groups.

After the rectified voltage Vrec rises to the upper limit level as described above, the rectified voltage Vrec may start to fall.

When the rectified voltage Vrec falls below the light emission voltage V4, the LED group LED4 may be turned off.

When the LED group LED4 is turned off, the light emitting state may be maintained through the LED groups LED3, LED2, and LED1. Thus, a current path may be formed by the switching circuit 33 connected to the LED group LED3.

Then, when the rectified voltage Vrec sequentially falls below the light emission voltage V3, the light emission voltage V2, and the light emission voltage V1, the LED groups LED3, LED2, and LED1 may be sequentially turned off.

In response to the sequential turn-off of the LED groups LED3, LED2, and LED1 of the lighting unit 20, the current path may be sequentially shifted among the switching circuits 33, 32, and 31. Furthermore, in response to the turn-off states of the LED groups LED1 to LED4, the level of the current If on the current path may also decrease in a stepwise manner.

The lighting unit 20 in accordance with the embodiment of the present invention may include a plurality of light emitting units, each of which includes one or more semiconductor packages having an equal number of LEDs mounted therein. The light emitting units may be arranged in the longitudinal direction in order to form a line light source, and the LEDs included in the light emitting units may be divided into a plurality of LED groups.

That is, each of the light emitting units may include one or more LEDs corresponding to each LED group. Furthermore, the light emitting units may be configured in such a manner that the number of LEDs included in one or more LED groups of which the light emitting orders are early is larger than the numbers of LEDs included in the other LED groups.

The light emitting units in accordance with the embodiment of the present invention may be mounted on a substrate (not illustrated) extended in the longitudinal direction. Each of the light emitting units may include a plurality of LEDs corresponding to a multiple of six.

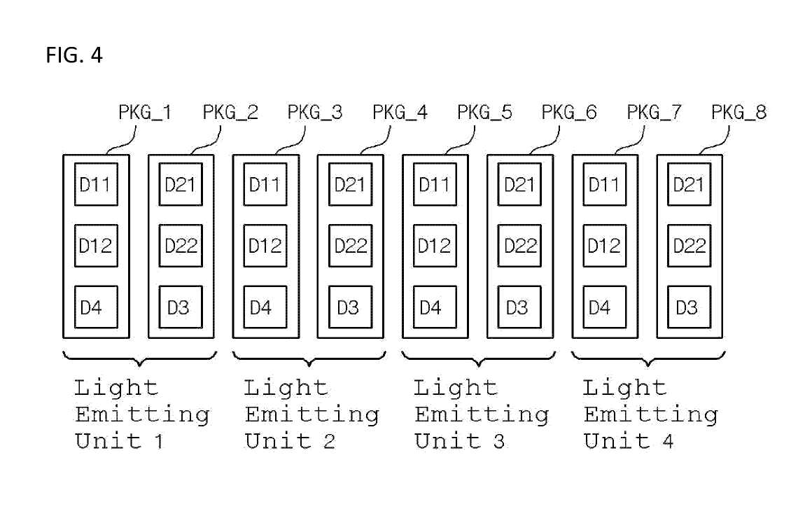

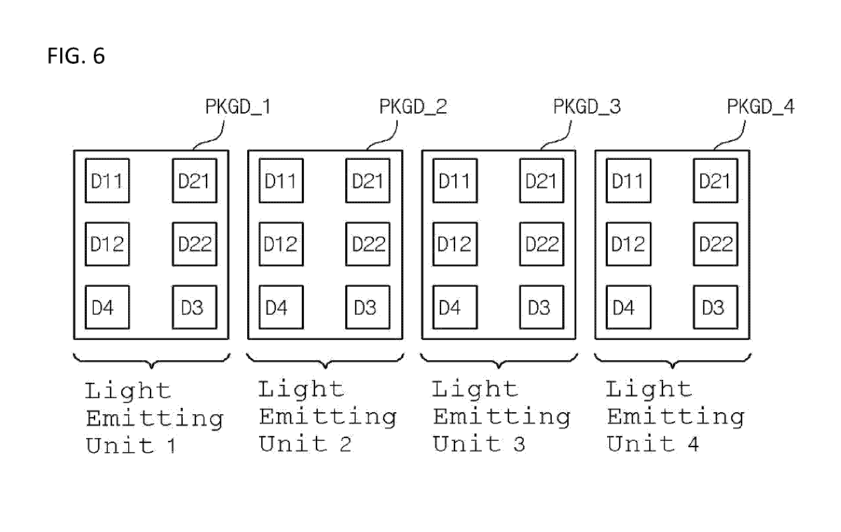

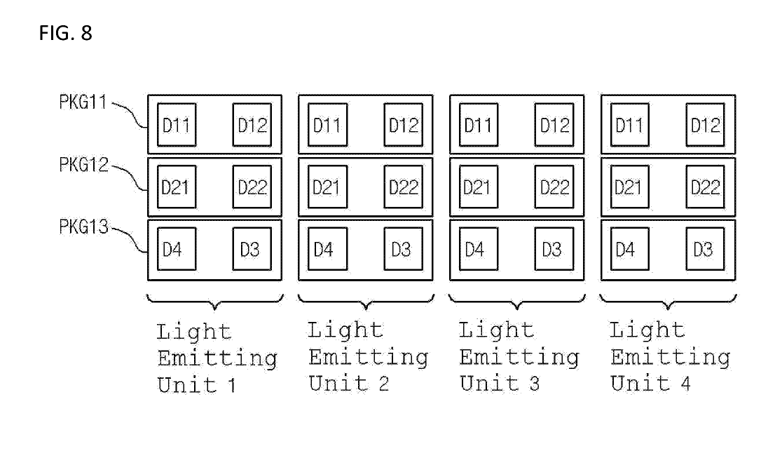

The light emitting unit including six LEDs may include two semiconductor packages each having three LEDs as illustrated in FIG. 4, include one semiconductor package having six LEDs as illustrated in FIG. 6, or include three semiconductor packages each having two LEDs as illustrated in FIG. 8. FIGS. 4, 6, and 8 illustrate that each of the light emitting units include six LEDs, but the embodiment of the present invention is not limited thereto.

Referring to FIG. 4, a light emitting unit 1 may include two semiconductor packages PKG_1 and PKG_2. Furthermore, the semiconductor package PKG_1 may include three LEDs D11, D12, and D4, and the semiconductor package PKG_2 may include three LEDs D21, D22, and D3. The light emitting unit 1 may include six LEDs D11, D12, D21, D22, D3, and D4. Among the LEDs, the LEDs D11 and D12 may be included in the LED group LED1, the LEDs D21 and D22 may be included in the LED group LED2, the LED D3 may be included in the LED group LED3, and the LED D4 may be included in the LED group LED4. The light emitting units 2 to 4 of FIG. 4 may include two semiconductor packages PKG_3 and PKG_4, PKG_5 and PKG_6, and PKG_7 and PKG_8, respectively. Each of the semiconductor packages PKG_3, PKG_5, and PKG_7 may include three LEDs D11, D12, and D4, and each of the semiconductor packages PKG_4, PKG_6, and PKG_8 may include three LEDs D21, D22, and D3.

The above-described semiconductor packages PKG_1 to PKG_8 may be arranged in a longitudinal direction to form a line light source. As a result, the lighting unit 20 of FIG. 4 may include the light emitting units 1 to 4 arranged therein, and form a line light source having three LED lines.

The LEDs D11, D12, D21, D22, D3, and D4 included in the light emitting unit 1 of FIG. 4 may sequentially emit light in order of the LEDs D11 and D12 included in the LED group LED1, the LEDs D21 and D22 included in the LED group LED2, the LED D3 included in the LED group LED3, and the LED D4 included in the LED group LED4.

That is, the LED groups LED1 and LED2 of which the light emitting orders are earlier in the light emitting unit 1 of the lighting unit 20 may include a larger number of LEDs than the other LED groups LED3 and LED4.

More desirably, the LEDs included in the light emitting unit 1 may be divided into the LED groups at an integer ratio. For example, the numbers of LEDs included in the LED groups LED1 to LED4 may be set to a ratio of 2:2:1:1.

When the light emitting unit 1 includes three LED groups, the total number of LEDs included in the light emitting unit 1 may be adjusted. The LEDs included in the light emitting unit 1 may be divided into the LED groups at an integer ratio. For example, the numbers of LEDs included in three LED groups may be set to a ratio of 2:1:1.

So far, the light emitting unit 1 has been described. However, since the other light emitting units included in the lighting unit 20 have the same configuration, the duplicate descriptions thereof are omitted herein.

The substrate having the light emitting units mounted thereon may include a first wiring and a plurality of second wirings formed thereon. The first wiring may transmit a rectified voltage to the light emitting units, and the plurality of second wirings may provide a current path to the plurality of LED groups. The first wiring may be formed on one surface of the substrate, and the plurality of second wirings may be formed on the other surface of the substrate.

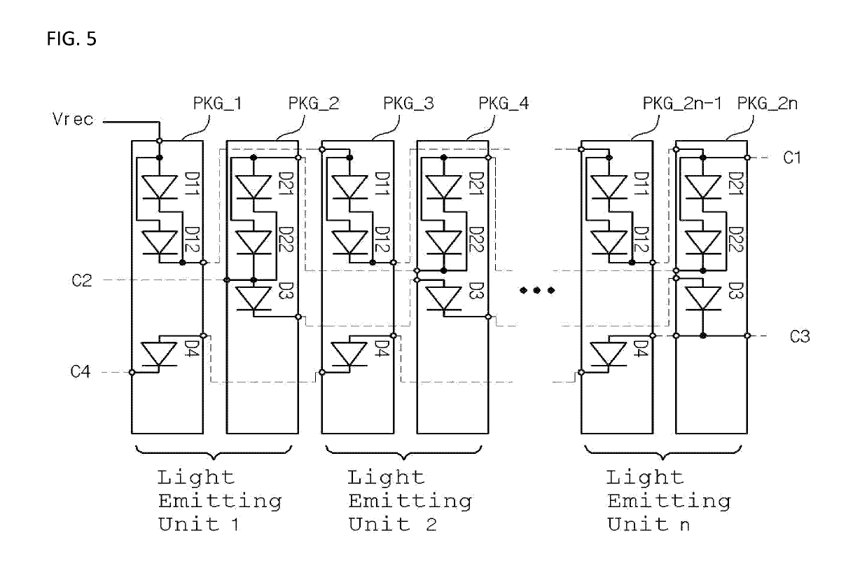

The circuit for the light emitting units arranged as illustrated in FIG. 4 may be configured as illustrated in FIG. 5. FIG. 5 illustrates that the lighting unit includes n light emitting units, where n is a natural number.

The LEDs D11 and D12 included in the LED group LED1 of each light emitting unit may be connected in parallel to each other. The LEDs D21 and D22 included in the LED group LED2 of each light emitting unit may also be connected in parallel to each other. The LED group LED1 may include serial connection of the LEDs D11 and D12 connected in parallel to each other in each light emitting unit. Furthermore, the LED group LED2 may include serial connection of the LEDs D21 and D22 connected in parallel to each other in each light emitting unit.

That is, the LEDs D11 and D12 connected in parallel to each other in the semiconductor package PKG1 of the light emitting unit 1 may be connected in series to the LEDs D11 and D12 connected in parallel to each other in the semiconductor package PKG_3 of the light emitting unit 2. The LEDs D21 and D22 connected in parallel to each other in the semiconductor package PKG_2 of the light emitting unit 1 may be connected in series to the LEDs D21 and D22 connected in parallel to each other in the semiconductor package PKG_4 of the light emitting unit 2. As described above, the LEDs D11 and D12 connected in parallel to each other and corresponding to the LED group LED1 of a light emitting unit may be connected in series to the LEDs D11 and D12 connected in parallel to each other and corresponding to the LED group LED1 of an adjacent light emitting unit. Furthermore, the LEDs D21 and D22 connected in parallel to each other and corresponding to the LED group LED2 of a light emitting unit may be connected in series to the LEDs D21 and D22 connected in parallel to each other and corresponding to the LED group LED2 of an adjacent light emitting unit.

Furthermore, the LED groups LED1 each including the LEDs D11 and D12 connected in parallel to each other in the respective light emitting units may be coupled in the forward direction from the light emitting unit 1 toward the light emitting unit n. On the other hand, the LED groups LED2 each including the LEDs D21 and D22 connected in parallel to each other in the respective light emitting units may be coupled in the forward direction from the light emitting unit n toward the light emitting unit 1.

Thus, a node to which the LEDs D11 and D12 and the LEDs D21 and D22 of the light emitting unit n are connected may be connected to the terminal C1 of the driving circuit 30.

The LED D3 of the semiconductor package PKG_2, included in the LED group LED3 of the light emitting unit 1, may be connected in series to the LED D3 of the semiconductor package PKG_4, included in the LED group LED3 of the adjacent light emitting unit 2. Furthermore, the LED D4 of the semiconductor package PKG_1, included in the LED group LED4 of the light emitting unit 1, may be connected in series to the LED D4 of the semiconductor package PKG_3, included in the LED group LED4 of the adjacent light emitting unit 2.

The LED groups LED 3 each including the LED D3 in the respective light emitting units may be coupled in the forward direction from the light emitting unit 1 toward the light emitting unit n. On the other hand, the LED groups LED4 each including the LED D4 in the respective light emitting units may be coupled in the forward direction from the light emitting unit n toward the light emitting unit 1.

Thus, a node to which the LEDs D11 and D12 connected in parallel and the LED D3 in the semiconductor package PKG_2 of the light emitting unit 1 are connected may be connected to the terminal C2 of the driving circuit 30. Furthermore, a node to which the LED D3 of the semiconductor package PKG_2n of the light emitting unit n and the LED D4 of the semiconductor package PKG_2n-1 are connected may be connected to the terminal C3 of the driving circuit 30. Furthermore, a node connected to an output terminal of the LED D4 of the semiconductor package PKG_1 of the light emitting unit 1 may be connected to the terminal C4 of the driving circuit 30.

Referring to FIG. 6, the light emitting unit 1 may include one semiconductor package PKGD_1. The semiconductor package PKGD_1 may include six LEDs D11, D12, D21, D22, D3, and D4.

The embodiment of FIG. 6 may have substantially the same configuration as the embodiment of FIG. 4, except that the six LEDs D11, D12, D21, D22, D3, and D4 are included in one semiconductor package PKGD_1. That is, the LEDs may be divided into LED groups. Thus, the duplicate descriptions thereof are omitted herein.

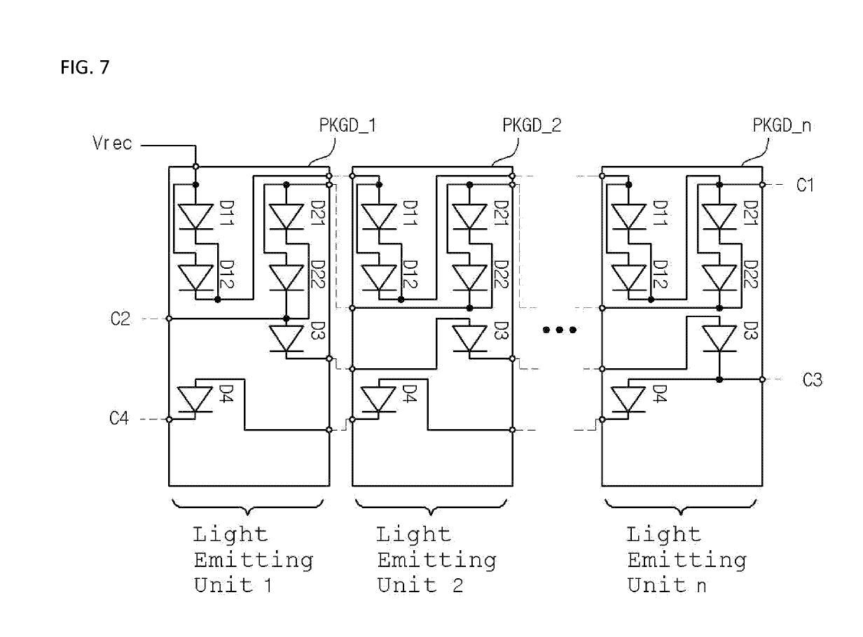

The circuit for the light emitting units arranged as illustrated in FIG. 6 may be configured as illustrated in FIG. 7. FIG. 7 illustrates substantially the same connection relation as the embodiment of FIG. 5. Thus, the duplicate descriptions thereof are omitted herein.

Referring to FIG. 8, the light emitting unit 1 may include three semiconductor packages PKG11 to PKG13. Furthermore, the semiconductor package PKGD11 may include two LEDs D11 and D12, the semiconductor package PKGD12 may include two LEDs D21 and D22, and the semiconductor package PKGD13 may include two LEDs D3 and D4.

FIG. 8 illustrates that three semiconductor packages are used to form one light emitting unit. The configuration of FIG. 8 may be modified in such a manner that the LEDs are arranged as illustrated in FIGS. 4 and 6. The light emitting unit of FIG. 8 may also include six LEDs.

Furthermore, the electrical connection between the LEDs corresponding to the same LED group in each of the light emitting units can be embodied with reference to FIGS. 5 and 7. The detailed descriptions thereof are omitted herein.

The lighting apparatus in accordance with the embodiment of present invention may be configured in such a manner that the light emitting units are arranged in the longitudinal direction as illustrated in FIGS. 4 to 8. Thus, the LEDs included in each of the light emitting units may be used to form a line light source.

Furthermore, the lighting apparatus may have a structure in which the LED groups to sequentially emit light are uniformly arranged for each of the light emitting units and the light emitting unit is repetitively formed. Thus, regardless of the position of the lighting unit extended in the longitudinal direction, uniform luminance can be provided.

Furthermore, the LED groups included in the light emitting unit may be set to divide the LEDs at an integer ratio. Thus, power consumption can be linearly induced. As a result, THD (Total Harmonic Distortion) can be improved.

While various embodiments have been described above, it will be understood to those skilled in the art that the embodiments described are by way of example only. Accordingly, the disclosure described herein should not be limited based on the described embodiments.

What is claimed is:

1. A lighting apparatus comprising a plurality of light emitting units each including one or more semiconductor packages having an equal number of LEDs mounted thereon,
wherein the light emitting units are arranged in order to form a line light source,
each of the light emitting units comprises a plurality of LEDs corresponding to a multiple of six,
the LEDs are divided into first to fourth LED groups which sequentially emit light, and
the numbers of LEDs included in the first to fourth LED groups, respectively, are set to a ratio of 2:2:1:1.

2. The lighting apparatus of claim 1, wherein each of the light emitting units comprises six LEDs.

3. The lighting apparatus of claim 2, wherein the light emitting unit comprises two semiconductor packages each including three LEDs.

4. The lighting apparatus of claim 2, wherein the light emitting unit comprises one semiconductor package including six LEDs.

5. The lighting apparatus of claim 1, wherein each of the light emitting units comprises one semiconductor package having 12 LEDs.

6. A lighting apparatus comprising a plurality of light emitting units including one or more semiconductor packages having an equal number of LEDs mounted thereon,
wherein the LED units are arranged in order to form a line light source,
the LEDs included in each of the light emitting units are divided into first to third LED groups which sequentially emit light, and
the numbers of LEDs included in the first to third LED groups, respectively, are set to a ratio of 2:1:1.

7. A lighting apparatus comprising:
a plurality of light emitting units arranged in order to form a line light source and each comprising one or more semiconductor packages having an equal number of LEDs mounted thereon and comprising a plurality of LEDs corresponding to a multiple of six; and
a driving circuit configured to selectively provide a current path to the plurality of LED groups in response to sequential light emissions of the plurality of LED groups according to changes of a rectified voltage,
wherein the LEDs included in each of the light emitting units are divided into first to fourth LED groups which sequentially emit light, and
the numbers of LEDs included in the first to fourth LED groups, respectively, are set to a ratio of 2:2:1:1.

8. The lighting apparatus of claim 7, wherein the LEDs distributed to the light emitting units are electrically connected in each of the LED groups, and the LED groups are connected in series to each other.

9. The lighting apparatus of claim 7, wherein the LEDs included in the same LED group in each of the semiconductor packages are connected in parallel to each other.

10. The lighting apparatus of claim 7, wherein each of the light emitting units comprises six LEDs.

11. The lighting apparatus of claim 10, wherein each of the light emitting units comprises two semiconductor packages each including three LEDs.
